(19) United States
(12) Patent Application Publication
(10) Pub. No.: US 2012/0107789 A1
(43) Pub. Date: May 3, 2012

(54) LEARNING ENVIRONMENT WITH USER DEFINED CONTENT

(76) Inventor: Kim Desruisseaux, Val-Des-Monts (CA)

(21) Appl. No.: 13/322,648

(22) Filed: Nov. 28, 2011

Related U.S. Application Data
(63) Continuation of application No. PCT/CA09/00758, filed on Jun. 2, 2009.

(51) Int. Cl. G09B 7/00

(52) U.S. Cl. 434/362

(57) ABSTRACT

The invention relates to providing a computer based learning environment for a user wherein the user defines the content to be studied. The learning tool allows students to store and arrange located information in respect of a study topic, the material being in many different formats and from many sources, explore that located information, reinforce the material by testing their comprehension and understanding, allowing them to enquire further by expanding the information themselves or by collaboratively acquiring additional information/testing. The information/content to be studied by the user is established as a series of questions with answer, the format and content of each being determined by the user. In studying the invention allows the stored information to be displayed for a particular topic, whereas in testing the invention includes the further step of the user determining whether their answer to the question was correct.

### CROSS-REFERENCE TO RELATED APPLICATIONS

This patent application claims the benefit of World Patent Application PCT/CA2009/000758 filed Jun. 2, 2009 entitled “Learning Environment with User Defined Content.”

### FIELD OF THE INVENTION

This invention relates generally to computer-aided learning methods and more particularly to learning environments where the user defines the content to be studied.

### BACKGROUND OF THE INVENTION

Learning is an ongoing process in life that requires continuous memorization and retention of new concepts, ideas, terms, names, etc. Although a variety of methods have been developed for building memory, there is a constant search for finding an effective and faster way for enhancing people's memorization process. Typically associated with children, at kindergarten, school and high-school, or students, at college and University, the process of learning is actually something that occurs throughout a person's lifetime and may do so across an extremely broad base of subjects as well as varying specificity of the required knowledge.

Additionally we are living in the midst of tremendous technological changes. In the workplace, technology is advancing and many of our job skills might become obsolete within years requiring that we learn new skills, or that we continuously augment our skills. Though technology is permeating gradually into every stratum of society and changing many aspects of it, it is very hard to keep up with these changes when we rely upon traditional structured educational materials to learn from. Whilst we may now purchase the educational materials directly from the comfort of our home via the Internet, rather than going to the local book store and purchasing it or registering and attending a course at a continued learning centre, the basic concept has remained unchanged. Technology has not generally been exploited to augment how a student learns but rather to reformat the traditional learning methods.

Learning by reading and/or by classroom instruction have been the conventional learning method for centuries. A typical provided learning material may contain sufficient explanatory contents to help a student to understand and memorize/retain the subject matter. However, purely reading the learning material and/or receiving classroom instruction related to the material is not the best way to memorize/retain the new concepts contained because a huge portion of the learning material is used not for helping the student to memorize/retain the concepts, but for helping the student to understand the concepts. Therefore, the student may in many instances be distracted in their learning process to grasp the core of the learning material. It is thus not uncommon that although, in a learning process, the concept may have to be explained in detail paragraph after paragraph, the core of the concept may only hinge on a few keywords, concepts or examples. Consequently, to learn or to memorize/retain the new concept depends in many instances on how well a student can memorize/retain this information.

Within the prior art many approaches to providing a software based educational tool have been presented including such as those by Ho et al in “Learning System And Method Based on Review”, U.S. Pat. No. 5,863,208; “Methods and Apparatus To Assess And Enhance A Student's Understanding In A Subject”, U.S. Pat. No. 5,779,486; “Relationship-Based Computer-Aided Educational System”, U.S. Pat. No. 5,727,951; “Reward Enriched Learning System And Method”, U.S. Pat. No. 5,743,746; and “Learning Method And System Based on Questioning”, U.S. Pat. No. 5,836,771.

Another approach is presented by D. R. Berman in U.S. Patent Application 2009/0023125 entitled “Lock-In training System Progress Display” which teaches to a method of providing a group of questions and answers, the answers including one or more keywords. A user can “lock-in material”, i.e. memorize it, by entering these keywords in response to questions which may be in introductory rounds and/or retention rounds on one or more training days. As with other similar solutions the questions and answers are pre-programmed into the application such that the student follows a pre-programmed course of instruction.

R. Warda in U.S. Patent Application 2008/0108035 entitled “Perpetual Educational System providing Continuous Personalized Learning Sessions based on a Comprehensive Knowledge Base” seeks to overcome the limitations of providing a modular based learning environment by providing a large database of questions and answers so that students of varying abilities can progress through the work at varying rates and those progressing quickly do not stop simply because they reach the end of a pre-programmed unit. Hence, in essence Warda teaches to combining all units or modules into one large database.

Further, J. J. L'Allier et al in “Interactive Learning System with Pretest”, U.S. Pat. No. 6,039,575, teach the creation of an automated learning sequence which includes pre-testing a user with at least one question from each of a plurality of learning objectives. The results of the evaluations of the pretesting process are used to produce a specific sequence of instructional units in response to those responses that varied materially from the respective standard. The sequence of instructional units is then presented to the user for interactive learning, all of which are derived from pre-programmed material.

However, in many instances a student will be learning outside of a structured environment such as a classroom or a training session. Such individual learning forms a significant element in the education of children and students with their home work, projects etc as well as for many individuals seeking to acquire new skills be they for their career or personal use such as in pastimes or other related activities. Importantly this individual learning also forms an important element with the learning theory of constructivism, as formalized predominantly by Jean Piaget in “La psychologie de l'intelligence”, published by Armand Colin (1961, 1967, 1991) and available online from University of Berkeley (http://sunsite.berkeley.edu/cgi-bin/ebind2html/psycholo), and “Logique et Connaissance scientifique”, see Encyclopedie de la Pléiade. This learning theory is therefore not addressed in prior art automated learning systems which are based upon a student learning from a predetermined series of lessons, which in computer based solutions in the prior art means a predetermined sequence of questions and retrieving information stored in a pre-programmed database of information.

Importantly studies of constructivism, for example Hmelo-Silver et al “Scaffolding and Achievement in Problem-Based and Inquiry Learning”, Educational Psychologist Vol. 42(2) pp99-107, indicate increased success for students using constructivist problem-based and inquiry learning methods. Further others such as J. S. Kim in “The Effects of a Constructivist Teaching Approach on Student Academic Achievement, Self-Concept, and Learning Strategies”, Asia Pacific Education Review, 6(1) p7-19, have shown that students prefer constructivist methods over traditional learning methods. As such constructivism engenders a desire or willingness to learn.
Whether or not constructivist approaches to education and learning continue within schools, colleges, Universities, and other learning institutions the fact of the matter is that a persons learning outside of these institutions is generally dominated by constructivist study. In undertaking such study a student today will be faced with information in many different forms and from multiple sources including:
   Books, Texts and Manuals are still the most common source for content for a student learning. But these may have the required information fragmented across multiple books requiring the student to have and multiple texts together;
   Instructors or Lecturers are another important source as a student will generally be combining individual learning/research together with structured education, and this provided learning material must be stored and accessed discretely in addition to the many books, texts etc the student identifies;
   Internet which over the past decade has dramatically increased the amount of information available to the student but has in other aspects made it harder for students by bombarding them with thousands or millions of website links from a search and either the website links the student considers appropriate must be bookmarked within the students computer to allow them to return to the same web pages or printed out in hard copy to add to the bulk of materials they must manage; and
   Digital Cameras, Digital Video, and Digital Audio which today with the prevalent and availability of low cost cameras, recorders and computer based editing software have meant that the amount of visual and audio-visual information available to students is significant, for example entering “how to cut an apple” into the Internet search engine Google™ returns approximately 8,300 video “hits” and over 11 million images, such that this information may provide an enhancement or alternative to the standard textual information outlined supra.

Accordingly today a student has available a massive amount of information which must be managed in many formats such as books, magazines, journals, Internet web pages, textual information, audio-visual information, etc. In many cases students find this an overwhelming task such that they struggle to actually learn spending more of their time managing the information rather than learning from it. Accordingly it would be beneficial to provide a learning environment wherein the student could easily integrate information from multiple sources into a single structured format so that after a stage of locating resource information they do not waste time relocating this resource information each time they sit down to study and learn.

Additionally other students can also provide content to a student, which today would be either by talking to one or by providing links to information by giving the student web page addresses (commonly referred to as “links” which are actually Uniform Resource Locator addresses, URLs). These may be helpful references the student hasn't come across. But again they must be integrated into the student's information resources. It would therefore be beneficial if another student having located and prepared their own study materials could share these with another student, and vice-versa such that a couple of students or small group could rapidly generate a significant learning resource without each expending considerable effort.

The above issues address three principal aspects, or steps, for a student learning process in respect of locating materials, exploring these materials and arranging them. Beyond this the remaining principal aspects are the reinforcement of the content and enquiring within the content to deepen the knowledge studied and increase understanding. Within a typical students self-directed learning these two steps are generally comprised of their reading their located resources repetitively and directing their reading as a result. In terms of reinforcing these materials by providing the student with a feedback of their retention prior to providing the learnt information within an environment such as a classroom, examination, test etc there is no mechanism the student can exploit on their own.

Accordingly it would be beneficial to provide the means wherein the located information is presented to the student in the form of questions to which answers are generated by the student and where repeated presentation of the question occurs until they pass a predetermined threshold of correct responses which imply they have absorbed and retained the information. Given that the located information which form the basis of these questions has been identified and located by the student absent a significant overhead in computing resources to isolate an answer and compare this to the students response it would be beneficial to have the student assess their correctness of response. In this manner a student absorbs pertinent information rather than learning by-rote specific responses to questions. As such an approach focused to low complexity and low processing requirements allows the learning tool to be employed within a wide range of devices including basic computers typical of third world environments rather than high end systems in North America, Europe, Japan etc. Further the low processing complexity allows the learning tool be added as an application on many mobile devices with Internet connectivity including cellular telephones, gaming consoles, etc.

It is, therefore, desirable to provide students with a educational tool that allows them to arrange located information in respect of a study topic, the material being in many different formats and from many sources, explore that located information, reinforce the material by testing their comprehension and understanding, and then allowing them to enquire further by expanding the information themselves or collaboratively acquiring additional information.

### SUMMARY OF THE INVENTION

It is an object of the present invention to obviate or mitigate at least one disadvantage of the prior art.

In accordance with an embodiment of the invention there is provided a computer based method of providing a user with a study aid comprising the steps of receiving from the user at least an indication of a subject matter for a plurality of study topics and storing the subject matter within a computer readable database, receiving from the user at least a first item of a plurality of first items, each first item of the plurality of first items representing a predetermined portion of a question, receiving from the user at least a second item of a plurality of second items, each second item of the plurality of second items representing a predetermined portion of an answer to the question, and storing the plurality of first items and the plurality of second items within the computer readable database as a study topic of the plurality of study topics together with at least an association to the at least an indication of the subject matter.

In accordance with another embodiment of the invention there is provided a computer based method comprising the steps of receiving from the user of a request to at least one of study and perform a test on a predetermined portion of the contents of the computer readable database, the request including an indication of the subject matter to be at least one of studied and the user tested on, retrieving a first study topic of the plurality of study topics, the first study topic being associated with the indicated subject matter and selected in a pseudorandom manner from the plurality of study topics associated with the indicated subject matter, presenting the plurality of first items of the first study topic representing the question to the user, receiving an indication from the user to present the answer to the question to the user, and presenting the plurality of second items of the first study topic representing the answer to the user.

In accordance with another aspect of the invention there is provided a system comprising, a microprocessor, a display, the display for presenting audio-visual information to a user of the system, at least one user input device and a user pointing device, the user input device for receiving information from the user and the user pointing device for controlling an object displayed to the user on the display, a first computer storage medium, the first computer storage medium having stored thereupon a computer readable database, a second computer storage medium, the second computer storage medium having stored thereupon a plurality of computer readable commands, wherein in operation the microprocessor retrieves and executes a first predetermined portion of plurality of computer readable commands such that in operation the system performs the following steps:
i) receiving from the user via the user input device at least an indication of a subject matter for a plurality of study topics and storing the subject matter within the computer readable database;
ii) receiving from the user via the user input device at least a first item of a plurality of first items, each first item of the plurality of first items representing a predetermined portion of a question;
iii) receiving from the user via the user input device at least a second item of a plurality of second items, each second item of the plurality of second items representing a predetermined portion of an answer to the question;
iv) storing the plurality of first items and the plurality of second items within the computer readable database as a study topic of the plurality of study topics together with at least an association to the at least an indication of the subject matter;
v) receiving from the user via at least one of the user input device and user pointing device a request to at least one of study and perform a test on a predetermined portion of the contents of the computer readable database, the request including an indication of the subject matter to be at least one of studied and the user tested on;
vi) retrieving from the computer readable database a first study topic of the plurality of study topics, the first study topic being associated with the indicated subject matter and selected in a pseudorandom manner from the plurality of study topics associated with the indicated subject matter;
vii) presenting the plurality of first items of the first study topic representing the question to the user via the display;
viii) receiving an indication via at least one of the user input device and the user pointing device a request from the user to present the answer to the question to the user; and
ix) presenting the plurality of second items of the first study topic representing the answer to the user via the display.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic of a typical student's self-directed learning environment;

FIG. 2 is an exemplary flow diagram representing the step of entering located information within the educational tool as a series of questions;

FIG. 3 is an exemplary flow diagram representing the step of testing the student with the located and stored information using the educational tool;

FIG. 4 is an exemplary flow diagram representing the step of capturing information and entering the captured information into the educational tool as questions with associated content and answers;

FIG. 5 is an exemplary flow diagram representing the step of searching social networks or specific contacts associated with the student for materials associated with a learning task and importing them into the educational tool;

FIG. 6 is an exemplary flow diagram representing the step of reducing the information stored within the educational tool by exploiting referenced external materials;

FIG. 7 is an exemplary flow diagram representing the step of asking questions to the student using information stored within the educational tool and exploiting referenced external materials to reduce memory requirements;

FIG. 8A illustrates an exemplary initial entry screen for the learning tool outlining available question sets and sub-sets;

FIG. 8B illustrates an exemplary user pop-up screen in respect to a question set within the learning tool;

FIG. 9 shows a user view of the learning tool where an exemplary series of questions for a selected question set are displayed;

FIG. 10 shows a user view of the question and answer entry window for the learning tool prior to any entries being made;

FIG. 11 shows the exemplary capture function employed in acquiring image and text information;

FIG. 12 shows an exemplary sequence for screen capture images for a study session in respect of a question set within the learning tool; and

FIG. 13 shows an exemplary sequence of screen capture images for a test in respect of a question set within the learning tool.

### DETAILED DESCRIPTION

The present invention is directed to providing an educational tool supporting learning by constructivist methods, employing content sourced by the student and progress monitored in dependence of the students own assessment of their accuracy in responding to questions.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

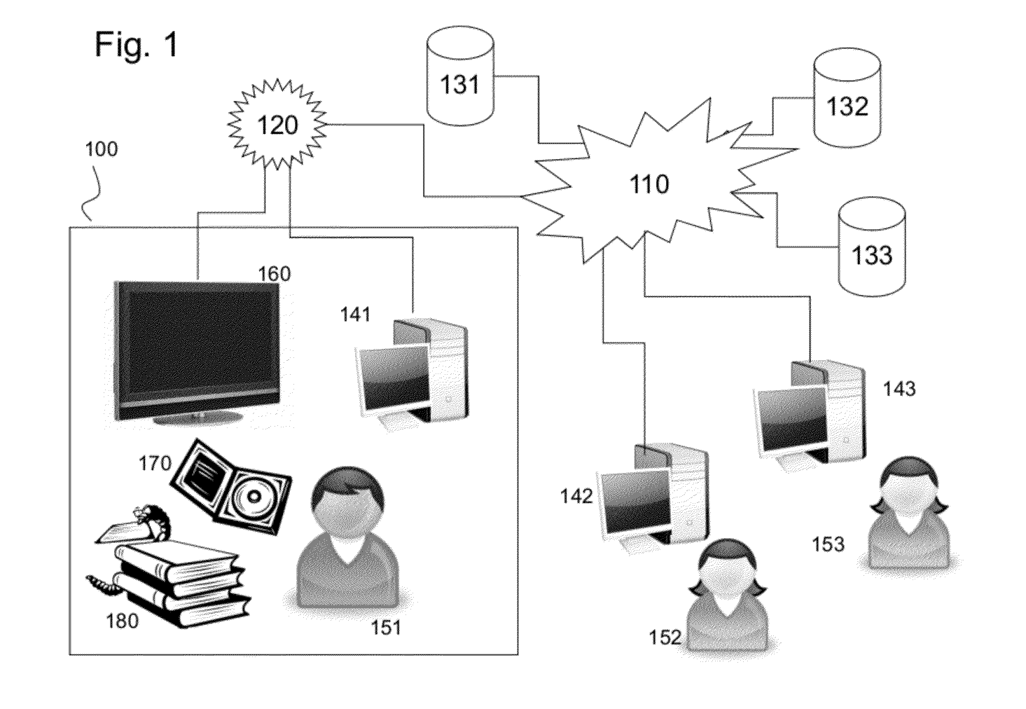

As illustrated in FIG. 1 a schematic of a typical student's self-directed learning, or constructivist learning, environment. As shown a student 151 is within their home 100 wherein they have materials relating to a learning activity which include a first computer 141, a television 160, computer media 170, and books 180. The first computer 141 and television 160 both being connected to a service provider 120 such as for example a cable television provider providing digital television and digital Internet over a single cable to the home 100. The student 151 is able via the first computer 141 to search for information on the World Wide Web (Internet) through their connection to the service provider 120 which in turn is connected to the Internet 110. Accordingly the student 151 in searching may access information stored anywhere such as on servers 131, 132, and 133 and other computers such as second computer 142 associated with first user 152 and third computer associated with second user 153. Second and third computers 152 and 153 may represent commercial sources of information, public domain repositories etc or may be links established via Peer-to-Peer (P2P) connections to friends, family members, lecturers or experts in the field of their current study. Accordingly the student 151 has access to multiple formats of information and through the Internet alone access to text, audio, visual and audio-visual content from hundreds of millions of hosted websites comprising billions of pages of information.

It would be evident to one skilled in the art that the student may access Internet content from a plurality of service providers and that these interfaces may be wireless links as well as wired links. Similarly the computer media 170 accessed by the user of the educational tool may include compact discs (CDs), flash memory drives (commonly referred to as memory sticks or USB drives), and external hard drives. Further the information sources outlined are not exhaustive as other sources may be utilized including audio equipment, such as radio, MP3 players, etc, and audio-visual equipment such as digital cameras, web cams etc. Similarly it would be evident that material contained within sources such as books for example may include magazines, journals, newspapers, and other printed media and these may be converted to electronic form by the student themselves via a device such as a scanner for example.

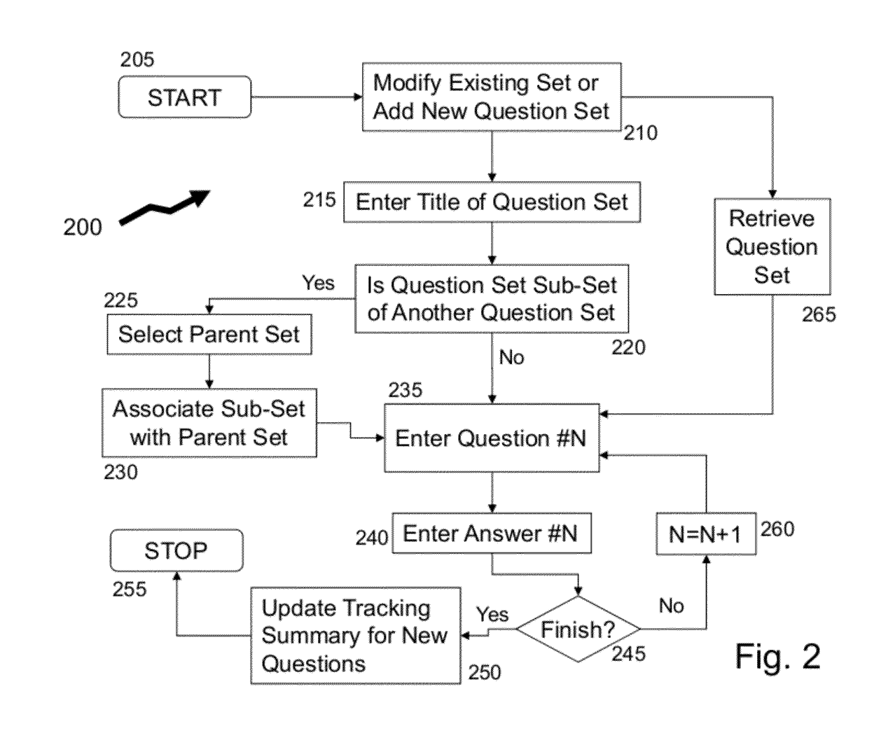

Referring to FIG. 2 there is shown an exemplary flow diagram 200 for entering questions and answers into an embodiment of the invention. As shown the process starts at step 205 with the selection by a user to add new questions to the database of the educational tool. The process then moves forward to step 210 where the user is prompted to determine whether the questions and answers being added represent a new question set or are modifying an existing question set. If the determination is a new question set the flow moves to step 215 and the user is prompted to enter the title of the question set, for example “larynx”, whereupon in step 220 they are prompted to determine if this new set is a sub-set of an existing question or a new subset. If the user determines they are a sub-set the process flow moves to step 225 and the user selects an existing set to add the new questions to as a sub-set. For example, the user has already established sets entitled “brain”, “limbs” and “organs” and wishes to associate larynx as a sub-set of organs. In step 230 this association is established and the flow moves forward to step 235 wherein the user enters question #N. If, however, at step 220 the user had determined that the questions were not a sub-set then the process would have moved directly to step 235 for the user to enter question #N and generated a new set “larynx” without associating them under “organs”.

Alternatively at step 210 if the user determined that the questions were to be added to an existing set the process flow would have moved to step 265 wherein the user would have selected an existing set of questions, for example “brain”, and the process would then have moved to step 235 for the user to enter question #N. Upon entering question #N at step 235 the process moves forward to step 240 and the user enters the answer #N to question #N. The process then moves to step 245 wherein the user determines whether they have finished entering questions and answers. If they determine no then the process moves to step 260 and the counter N is updated by 1 and the process cycles through steps 235 and 240 each time until the user determines they are finished. Upon that event the process moves to step 250 wherein the tracking summary of questions is updated to add the new questions and their associations within the family tree of sets, and the process then moves to step 255 and stops.

It would be apparent therefore that the user can create sub-sets and sets of questions as their studies progress in a manner that at the end they have a hierarchal structure allowing them to revise from top level aspects such questions relating to the human body in general down to specific organs etc. Accordingly as students generate question sets during the course of study a master question set is then generated allowing them to review all material covered in that course, semester, or year in preparation for examinations etc.

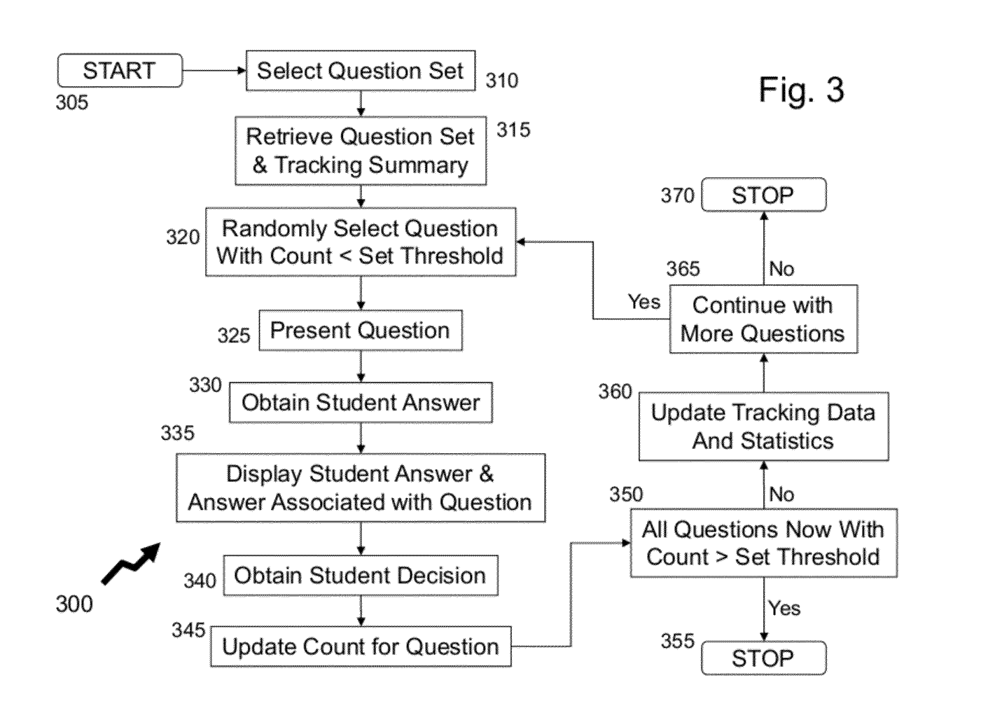

Now referring to FIG. 3 there is shown an exemplary flow diagram 300 representing the step of testing the student with the stored questions using the educational tool. The process begins at step 305 where the student selects testing as the desired option from a menu of options presented by the educational tool. Upon making this selection the process moves to step 310 and the user is prompted to select the question set, for example “organs” which would then include the recently entered sub-set “larynx” along with those previously entered such as “heart”, “kidney”, and “liver”. Upon selecting the question set this is retrieved in step 315 along with the tracking summary that contains at least the questions and answers, or links thereto, and a status of the students' responses to each question.

The educational tool then randomly selects a question from the question set in step 320 and presents the user with a question at step 325 and progress to step 330 wherein the user enters their response to the question. Next at step 335 the user is presented with both the answer they entered at step 330 and the stored answer associated with the question. Then at step 340 the student determines and enters their assessment of whether they correctly answered the question, this determination then being used in step 345 to update a count of correct answers associated with the question.

The educational tool now proceeds to step 350 wherein a determination is made as to whether all questions within the sub-set have now been answered a number of times exceeding a predetermined threshold. If all questions have been answered correctly for example three times the process then moves to step 355 and stops. If not all questions have been answered correctly the process moves forward to step 360 and updates tracking data and statistics. The process then moves forward to step 365 wherein a determination of whether to continue with more questions is made, wherein if the user determines no the process moves to step 370 and stops. If yes then the flow moves back to step 320 and a randomly selected question from those remaining is made and presented to the user. In this manner the educational tool cycles through the questions randomly until the user has answered them all the requisite number of times.

In randomly selecting the question from the question set in step 320 the process 300 only selects from those within the question set that have not been “passed” thereby demonstrating their retention of that item of information. During a current session the process 300 would work through all questions within the set or sub-set before repeating any. As such the process 300 may track the number of times the user correctly answers the question and upon meeting a predetermined threshold the question is not repeated again.

It would be evident that the user may additionally be asked whether they wish to include or omit all sub-sets or a predetermined sub-set of sub-sets when selecting a parent set so that they address only those questions relating to the parent set specifically or the sub-sets not omitted. For example the user may select “organs” and wish to only be tested on “larynx”, “nose”, “throat” and “ear”. Also the count of correct answers may be one of several counts updated as it may be desirable to count the number of times the question has been asked, how many times it was asked before the user got it correct, etc. Such information may be useful when returning to the subject matter for a refresher test etc.

It would also be evident to one skilled in the art that the predetermined threshold relating to the number of times a question must be answered correctly before it is removed from the list may be established as a preset value within the computer aided learning tool or may be a variable established by the user.

Further it would be apparent that information such as tracking statistics might be transmitted from the educational tool to another computer, for example one associated with the students' teacher, allowing them to determine whether the student is making good progress, has collated sufficient questions and answers, etc. Similarly the threshold for determining when something has been “learnt”/“retained” i.e. the question has been marked as answered correctly by the user enough times, may be constant or a variable established by default in the educational tool, by the user, by the users' teacher, or adjusted according to whether the subject matter is being learnt a first time or being repeated.

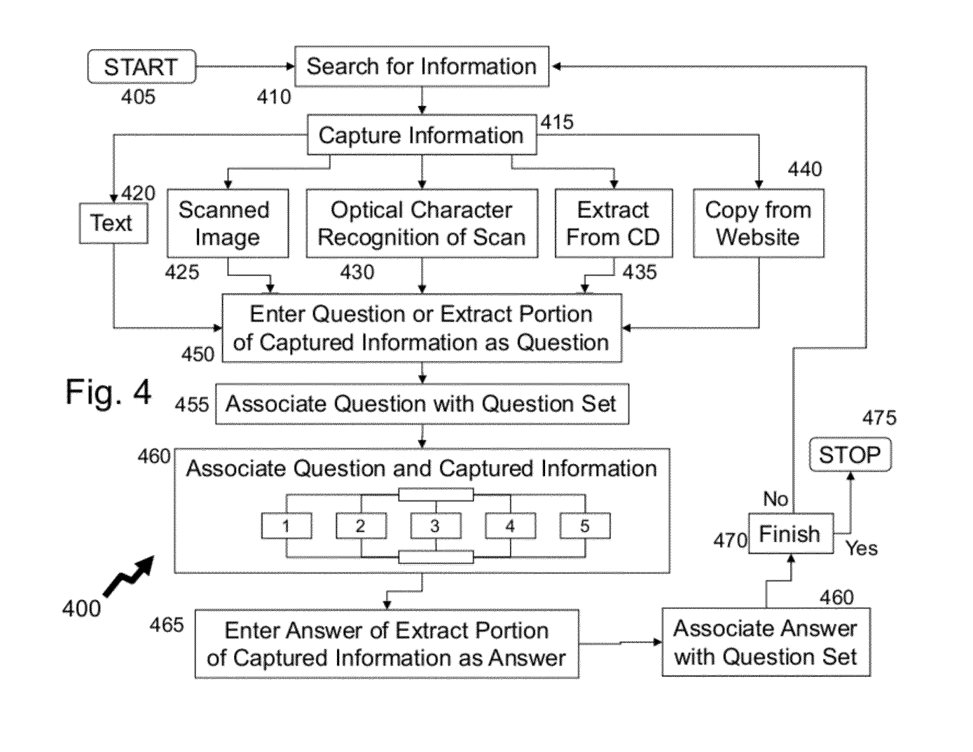

Referring to FIG. 4 there is shown an exemplary flow diagram 400 representing the step of capturing information and entering this captured information into the educational tool as questions with associated content and answers. As such FIG. 4 represents an exemplary flow for a user collating content from multiple sources with or without typing entries themselves whereas FIG. 3 represented a more traditional text entered question and answer environment within the educational tool. The process starts at step 405 where the user launches the educational tool in addition to other applications on their computer. Next at step 410 the user searches for information related to a topic they are learning and upon finding something they wish to capture selects the capture feature of the educational tool in step 415. In progressing from this step to the step 450 of entering the question or extracted portion of the captured information as the question the exact process may take one of several paths according to the source of the information.

As shown the exemplary flow of FIG. 4 shows five different paths. The first path with step “Text” at step 420 represents the capturing of information from a text based source, such as a document stored on the users' computer, copied from a webpage, typed etc. Whilst similar to the process in FIG. 3 above the users operations here are typically “point-and-click” with a haptic interface, such as a computer mouse or touchpad, than actually typing the information. The second path with step “Scanned Image” 425 represents one where the user takes information from a printed media source such as newspaper, magazine, book etc and scans this into the computer via a scanner. In the third path with step “Optical Character Recognition of Scan” 430 a scanner connected to the computer provides the scanned portion of the document to an Optical Character Recognition (OCR) application wherein the OCR converts the scanned portion to text.

In the fourth path with step “Extract From CD” 435 the educational tool allows the user to select content from the directory structure of a CD. This CD may contain text, audio content, visual images or audiovisual content in one of a number of common formats for storing said information. In this path the user does not need to consider the format of the stored information as the educational tool contains the requisite driver interfaces and converters to accept most common formats such as JPEG, TIFF, GIF, Bitmap, MP3, WMA, PDF, TXT, etc.

In the fifth path with step “Copy from Website” 440 the education tool allows the user to dynamically select from a webpage or website which the user is viewing with their Internet browser, such as Microsoft™7 Internet Explorer® for example. As such the user may select text, visual images, graphical data etc. In this path, as with fourth path “Extract from CD” 435 the user does not need to consider the format of the information being captured as the educational tool captures the displayed information in a common format.

Having selected the required content using one of the five paths 420 through 440 the process moves forward to step 450 and the user enters the question or the captured information as the question whereupon the process moves forward to step 455 and associates the captured information with the question number and the appropriate set or sub-set of questions. The process then moves to step 460 wherein the user is prompted to enter the answer to the question or extract a portion of the captured information as the answer. As such within step 460 the process essentially repeats steps 415 through 450 and provides the user with multiple options for capturing the answer, including but not limited to, text, scanned image, optical character recognition of scan, extract from CD and copy from website as outlined supra.

Upon capturing the information in step 460 the process moves forward to step 460, associates the extracted information as the answer and moves forward to step 467 wherein the process associates the answer with the question and the question set. The process then moves to step 470 and prompts the user as to whether they wish to continue with capturing information and generating the question set. Accordingly if the user wishes to stop then the process moves to step 475 and terminates, otherwise the process returns to step 410 and repeats through steps 410 to 470 until the user elects to stop generating questions and answers.

It would be apparent to one skilled in the art that alternative configurations for the entry of question and answer sets exist which fall within the scope of the claimed invention. For example, the user may generate a question and associated answer and then be prompted to associate this pair with a question set if in some circumstances a user may extract information from content sources and associate with multiple question sets, such an approach offering enhanced user appeal as they do not have to repeatedly go back through content sources such as webpages, CDs, text books etc. Further the learning tool may maintain the format of the acquired content or may change the format to a standard one for the learning tool, which may be proprietary.

The generation of content is an important step in the acquisition of knowledge about a given subject and learning it. However, in many instances the amount of information may be significant and hence a method of acquiring information by the user other than entering it all may be beneficial. Unlike conventional learning tools wherein the information set is predetermined the invention allows the user to dynamically add and expand the information set for any particular topic.

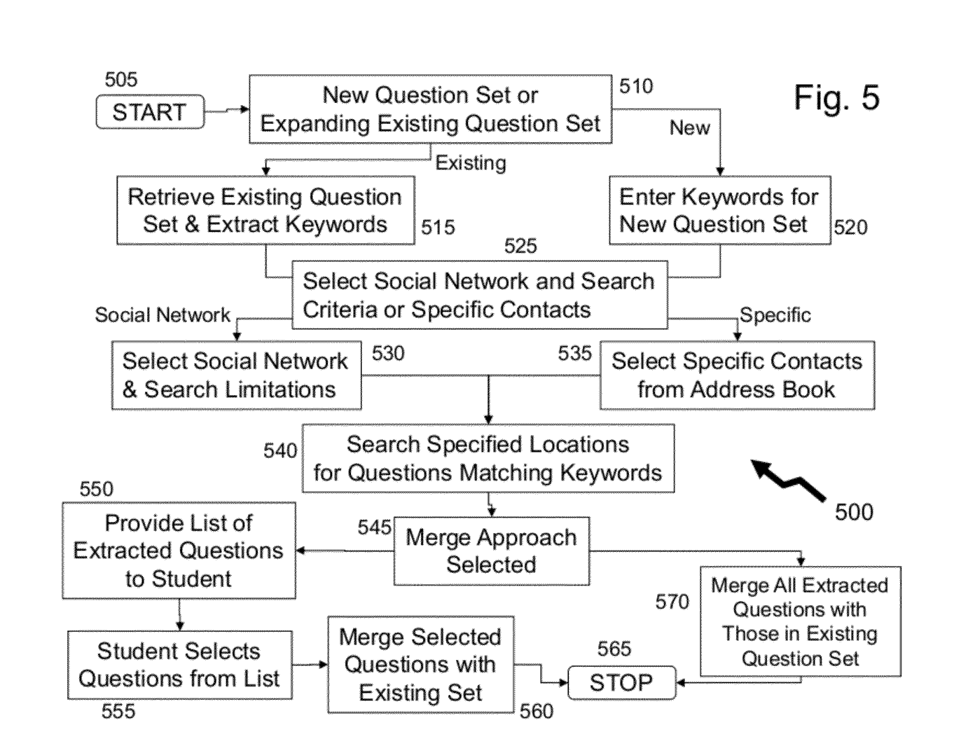

Referring to FIG. 5 there is shown an exemplary flow diagram 500 wherein a user searches social networks or specific contacts associated with the user for materials associated with a learning task and importing them into the educational tool. Typically a user today will not only have an email address associated with themselves allowing them to receive information but they may be members of one or more social networks which may range from networks examples such as “FaceBook”, “Classmates”, “Flixter”, “Friendster”, “Haboo”, “LinkedIn”, “MySpace”, “Orkut”, and “Windows Live Space” which are general social networks to those associated with particular interests, including for example “Last.fm” and “imeem” which are associated with audio-visual entertainment, “ResearchGATE” for academic researchers, and “NurseLinkUp” for nursing staff, “MyArtSpace” for architecture and visual media.

As a result a user may have friends within these social networks who are studying the same subject matter and accordingly the exemplary flow diagram 500 allows them to search for such content and merge with their content to generate a large learning database for a particular subject. Accordingly the process starts at step 505 and moves to step 510 wherein the user is prompted to establish whether the content that will be acquired is for a new question set or expanding an existing question set. If the question set is new then the process moves forward to step 520 wherein the user is prompted to enter keywords associated with the topic they wish to learn at which point the process moves forward to step 525 for the user to select where to search.

If the user selected expanding an existing question set then the process moves to step 515 and the learning tool retrieves the existing question set and extracts a set of keywords before moving forward to step 525. At step 525 the user is prompted to enter whether they wish to search a broad database or a specific set of contacts. If the user selects a broad database search then the process moves to step 530 and the user selects the social network and any search limitations. Accordingly the search may be all their friends on “FaceBook”, all “MySpace” users within the Province of Ontario between the ages of 9 and 11 (i.e. within and around the grade range of their current subject), all users on “LinkedIn” etc. The process then moves forward to step 540 to begin searching.

If the user selects a specific set of contacts then process moves forward to step 535 and the user is presented with their contacts from a specific social network or sub-set of social networks allowing them to select the users. The process then moves forward to step 540 and the learning tool begins searching the specified locations for questions and/or question sets that match the keywords. Upon identifying all questions associated with the keywords in the search the process moves forward to step 545 and prompts the user to select the approach they wish to employ in merging the retrieved questions.

If the user selects to merge all extracted questions then the process moves forward to step 570 wherein all retrieved questions are merged with the existing question set after which the process moves to step 565 and stops. If, however, the user selects to determine which questions to add then the process moves forward to step 550 and the user is provided with the list of extracted questions such that in step 555 they can select those they wish to add. Upon selecting the questions they want the process moves forward to step 560 wherein the selected questions are merged with the existing question set and then proceeds to step 565 and stops.

It would be evident to one skilled in the art that the identification of questions sets associated with the keywords entered by the user may vary according to the social network being accessed, the user information stored, etc. Accordingly the search may be performed on a centralized server cluster of the provider of the social network, upon computers associated with the user by the social network (such as through their repeated accessing the social network from a given IP address), etc. According to the rights granted by the users to the social networking sites the search may be granted access automatically to the other users' stored information or the access may be requested and granted in response to a contact message generated to the contacts from the learning tool. Alternatively a user of the learning tool may grant rights to the learning tool provider allowing users to search a database of the registered users of the learning tool to find those meeting criteria such as age, location, sex etc and then search their stored information for questions matching the user's questions. In this scenario the search may be limited to a specific sub-set of the contacts stored information as the learning tool knows which directories the question sets are stored within. It would be also be apparent to one skilled in the art that the users question set may be stored for example upon a single computer, upon multiple computers associated with the user, and a remote server.

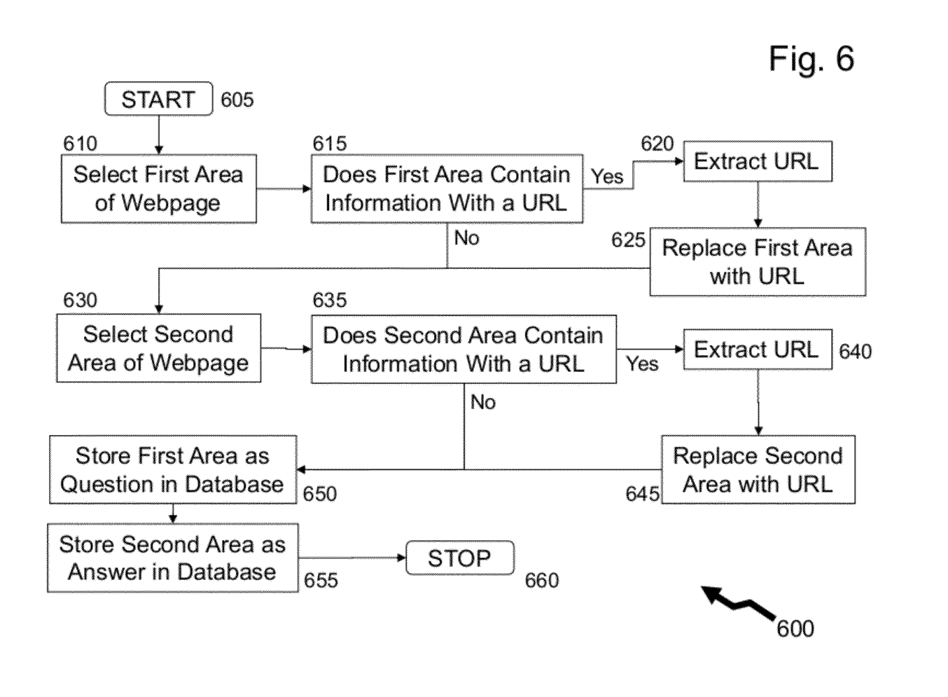

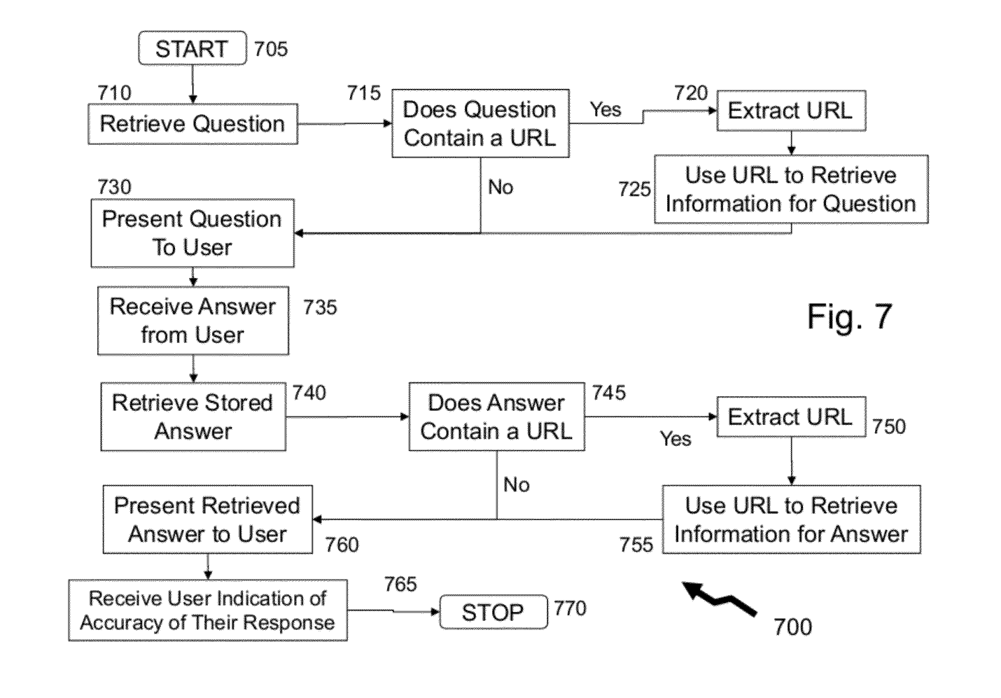

In some circumstances the information content being acquired by the user may not be suitable for capture with a simple “point-and-click” type operation using a web browser or other tool. For example, the user conducts a web search for “carburetor and retrieves a weblink to YouTube™ for a Shell™ Oil video “How an Engine Works Pt 2—Carburetor” which is a video and hence not capturable under normal circumstances despite its educational content. In other situations the amount of information may be significant such that methods of reducing memory usage would be beneficial. For example the user is searching for information wheat production in China and wishes to use a map for the distribution of winter wheat in China acquired from satellite radar on the Foreign Agricultural Service arm of the US Department of Agriculture (http://www.fas.usda.gov/pecad2/highlights/2001/04/CHWheat/hen328.gif). This image takes 200 kB when selected and the user is employing a wireless device such as Blackberry Storm with a 128 MB memory card or an Internet enabled Nintendo Wii™ with only 510 MB memory to execute the learning tool such that they have limited storage available. As such a process of reducing memory required upon selecting content for questions/answers and subsequently expanding said reduced information when presenting the questions/answers to the user would be beneficial, such an exemplary store and retrieve process being shown in FIGS. 6 and 7 below.

Referring to FIG. 6 is an exemplary flow diagram 600 representing the step of reducing the information stored within the educational tool by exploiting referenced external materials. Accordingly at step 605 the reduction process represented by exemplary flow diagram 600 starts wherein the user selects a first area of a webpage at step 610 and the process moves ahead to step 615 wherein the reduction process seeks to establish whether the first area contains information with a Universal Resource Locator (URL). If no, then the process moves ahead to step 630. If the first area does contain a URL then the process moves forward to step 635, extracts the URL and then in step 625 replaces the captured first area with the URL at which point the process similarly moves to step 630.

In step 630 the user selects a second area of a webpage and the process moves ahead to step 635 wherein the reduction process seeks to establish whether the second area contains information with a URL. If no, then the process moves ahead to step 650. If the second area does contain a URL then the process moves forward to step 640, extracts the URL and then in step 645 replaces the captured second area with the URL at which point the process similarly moves to step 650. In step 650 the first area is then stored within the database as the question, the process moves to step 655 to store the second area as the answer to the question and moves forward to step 660 and stops.

Now referring to FIG. 7 there is shown an exemplary flow diagram 700 representing the step of asking questions to the student using information stored within the educational tool and exploiting referenced external materials to reduce memory requirements is presented. The process starts at step 705 which is part of a question and answer process and moves to step 710 to retrieve the next question to present to the user, and then moves to step 715 wherein the learning tool establishes whether the retrieved question contains a URL. If there is no URL the process moves forward to step 730, whereas if there is a URL the process moves to step 720 to extract the URL before moving to step 725 wherein the URL is used to retrieve the information to be used for the question before moving to step 730 wherein the information is presented to the user as the question.

The process then moves to step 735 where the learning tool receives an answer from the user before moving forward to step 740 to retrieve the stored answer. The process then moves to step 745 wherein the learning tool establishes whether the retrieved answer contains a URL. If there is no URL the process moves forward to step 760, whereas if there is a URL the process moves to step 750 to extract the URL before moving to step 755 wherein the URL is used to retrieve the information to be used for the question. The retrieved answer is then presented to the user in step 760 whereupon the process moves to step 765 where the user provides the indication of the accuracy of their response to the question compared with the retrieved answer. The process then moves to step 770 and stops.

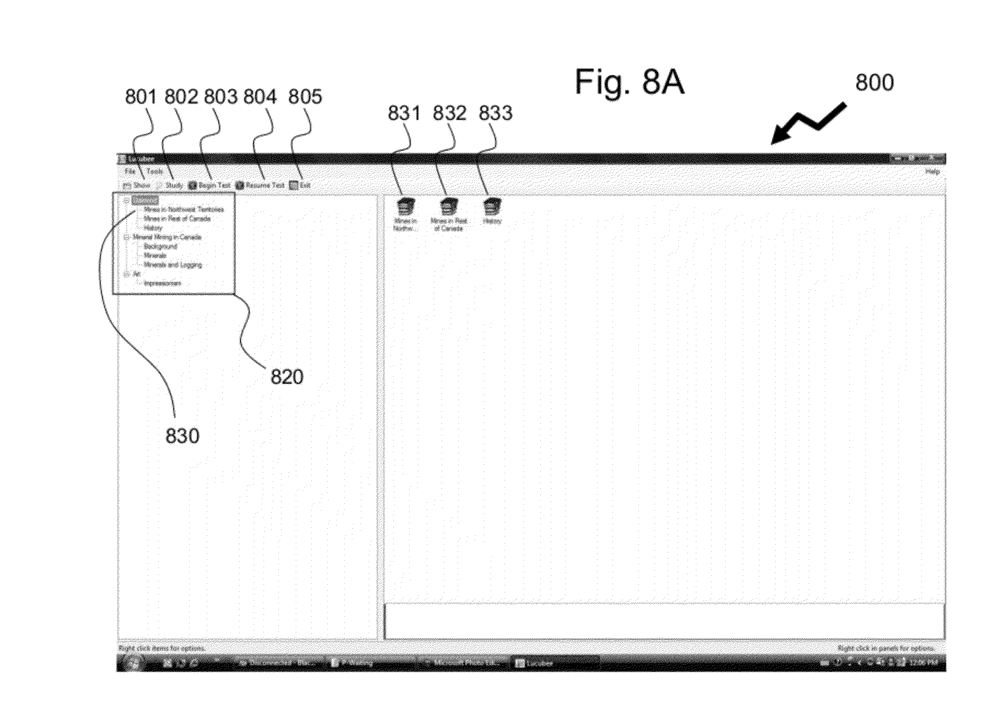

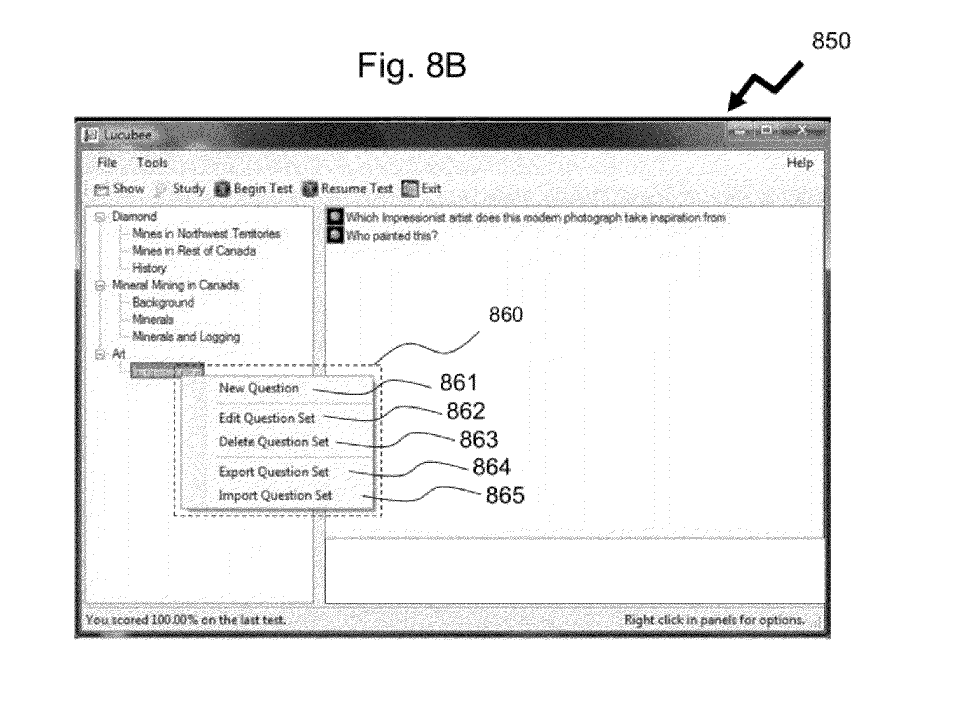

Referring to FIG. 8A there is illustrated an exemplary initial entry screen 800 for the learning tool. As shown a screen question set “Diamond” 830 is highlighted from within the list of question sets and sub-sets 820. Across the top bar of the window 810 the user is presented with five options:
“Show” 801—which presents the first question from the question set “Diamond” 830 to the user who may then view each entered question and answer and move sequentially through “Diamond” 830 allowing them to review the question set;
“Study” 802—which presents the questions randomly from “Diamond” 830 and then allows the user to display the answer before moving to the next randomly selected question, so that the user can revise from the materials entered into the question set “Diamond” 830;
“Begin Test” 803—which presents a question randomly selected from the question set “Diamond” 830 to the user, awaits his selection to display the answer and then asks the user to mark their response to the question;
“Resume Test” 804—which allows a user to re-start an already initiated test; and
“Exit” 805—which allows the user to exit the learning tool and shuts down the window 810.

In the right hand side of window 810 three icons show that the topics “Mines in Northwest Territories” 831, “Mines in Rest of Canada” 832 and “History” 833 which are sub-sets of questions relating to “Diamond” 830 and not individual questions.

Now referring to FIG. 8B there is illustrated an exemplary user pop-up window 860 in respect to a question set within the learning tool for user display 850. The user has previously selected the “Impressionism” sub-set from the set “Art” and upon right-clicking their mouse the pop-up window 860 appears presenting them with a series of options in respect to this set of questions:
“New Question” 861 allows the user to enter a new question to the question set “Impressionism”
“Edit Question Set” 862 allows the user to change the name of the question set “Impressionism” or amend the description associated with this title;
“Delete Question Set” 863 allows the user to completely remove the question set “Impressionism” from the learning tool;
“Export Question Set” 864 allows the user to export the question set to memory on the users computer in a standard format for the learning tool allowing it to be shared with other users; and
“Import Questions Set” 865 allows the user to import a question set stored previously by themselves or acquired from another user.

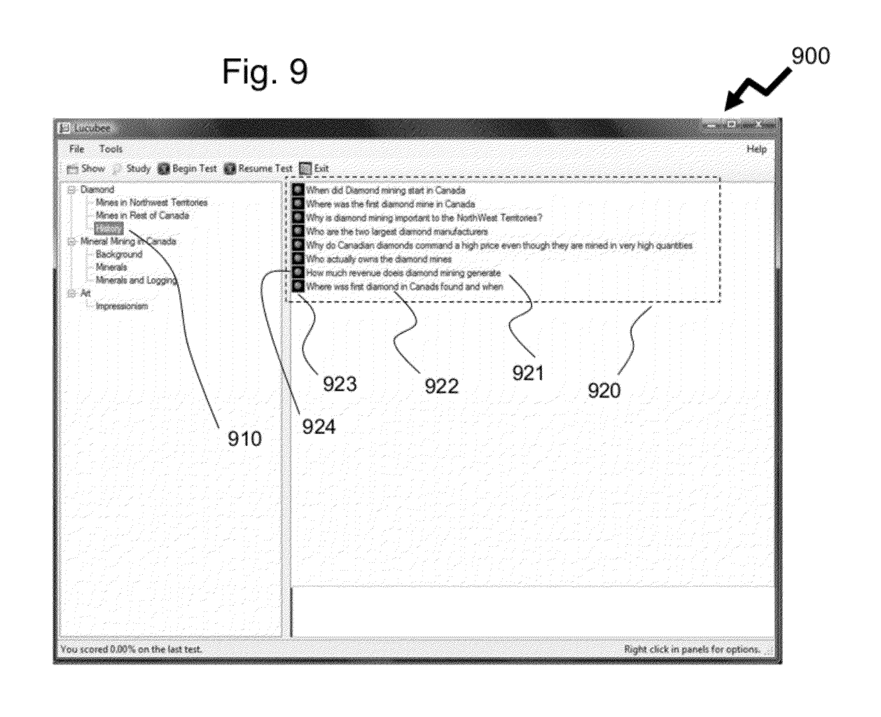

Referring to FIG. 9 there is shown an exemplary user display 900 when the user has selected “History” 910 from the question set “Diamond”. Accordingly the right hand side of the screen now shows a list of the questions contained with the sub-set “History” 910. Accordingly there is shown “How much revenue doeis diamond mining generate” 921 and “Where was the first diamond in Canada found and when” 922. Next to each question is a progress icon, hence “How much revenue doeis diamond mining generate” 921 is associated with first progress icon 924 and “Where was the first diamond in Canada found and when” 922 is associated with second progress icon 923. The first and second progress icons 923 and 924 respectively change when the user correctly answers the question a predetermined number of times during the testing stage. As such the user has a very quick visual representation of their progress. For example the icon may change color from red to green, or alternatively the icon may change image, have effects added, etc. It would be apparent to one skilled in the art that such alternatives achieve the same result.

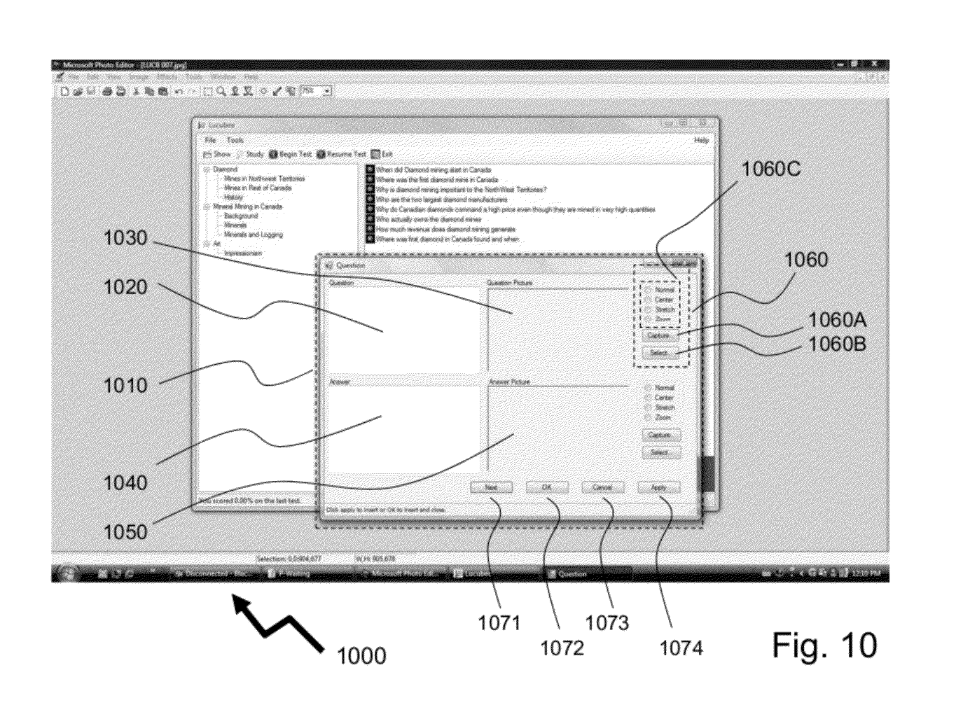

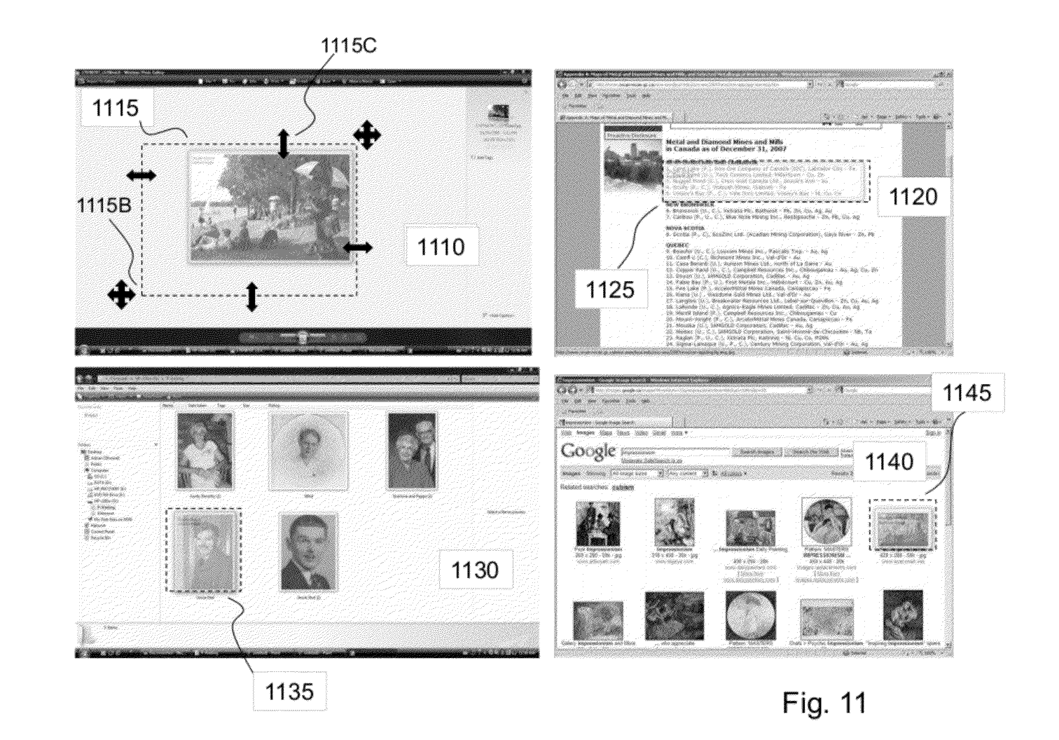

FIG. 10 shows a user view 1000 when the “New Question” option was selected, such as for “New Question” 861 supra. Upon selecting this option a compile window 1010 appears. Within the compile window 1010 are four panes 1020 through 1050 as well as other options for the user to select from which will be outlined below. First pane 1020 entitled “Question” allows the user to enter a text based question into that first pane 1010. Second pane entitled “Question Picture” 1030 allows the user to associate captured information with the text based question or alternatively only enter captured information for the question. To acquire the window for “Question Picture” 1030 the user first selects “Capture” 1060A or “Select” 1060B. “Select” 1060B provides the user with a normal directory listing allowing the user to select a content file stored on their computer. “Capture” 1060A results in a semi-transparent capture window appearing on the screen allowing the user to capture content displayed on the screen of their computer. This will be described in more detail below in respect of FIG. 11.

Upon acquiring the content for the “Question Picture” 1030 the user may adjust the image using “Normal/Center/Stretch/Zoom” buttons 1060C. The user may now enter an answer to the question in the third pane “Answer” 1040 as text or repeat the process of acquiring an image from the display of the users computer or from their hard drive etc using the “Capture” 1060A, “Select” 1060B and “Normal/Center/Stretch/Zoom” buttons 1060C and entering this within the fourth pane “Answer Picture” 1050. The user may select whether a question is entirely text based, entirely image based, or a combination thereof in completing all four panes 1020 through 1050. If the user wishes to enter another question to the set they then select “Next” 1071 wherein the process moves forward to present a new empty compile window 1010, if they have finished entering questions to the question set then they select “OK” 1072 and they return to a previous screen such as user display 900. If the user decides not to finish the question or decides upon completion to scrap the question then they select “Cancel” 1073. If the user selects “Apply” during the compilation of the question then the database is updated and the process stays with the compile window 1010 until the user completes the entry or cancels.

FIG. 11 shows the exemplary capture function employed in acquiring image and text information such as for the “Question Picture” 1030 and “Answer Picture” 1050 supra in FIG. 10. Upon selecting “Capture” 1060A the learning tool hides the tool window from view leaving the user viewing the screen of their PC with whatever windows are open at that point. A semi-transparent window 1115 is shown to the user who can manipulate the position, size and aspect ratio of the semi-transparent window 1115 relative to the display of the PC 1110 to select the picture, image, content they wish to import. Double clicking of the semi-transparent window 1115 closes it and the learning tool reopens with the captured content inserted into the one of “Question Picture” 1030 and “Answer Picture” 1050 according to the process currently being undertaken. The semi-transparent window 1115 is manipulable by its corners 1115B or sides 1115C. Accordingly as shown the semi-transparent window 1115 is positioned over a photograph viewed with Windows PhotoGallery in first screen view 1110, a block of text 1125 from an Internet accessed webpage in second screen view 1120, a first image 1135 viewed with Windows Explorer in third screen view 1130, and a second image 1145 from Google search results in fourth screen view 1140.

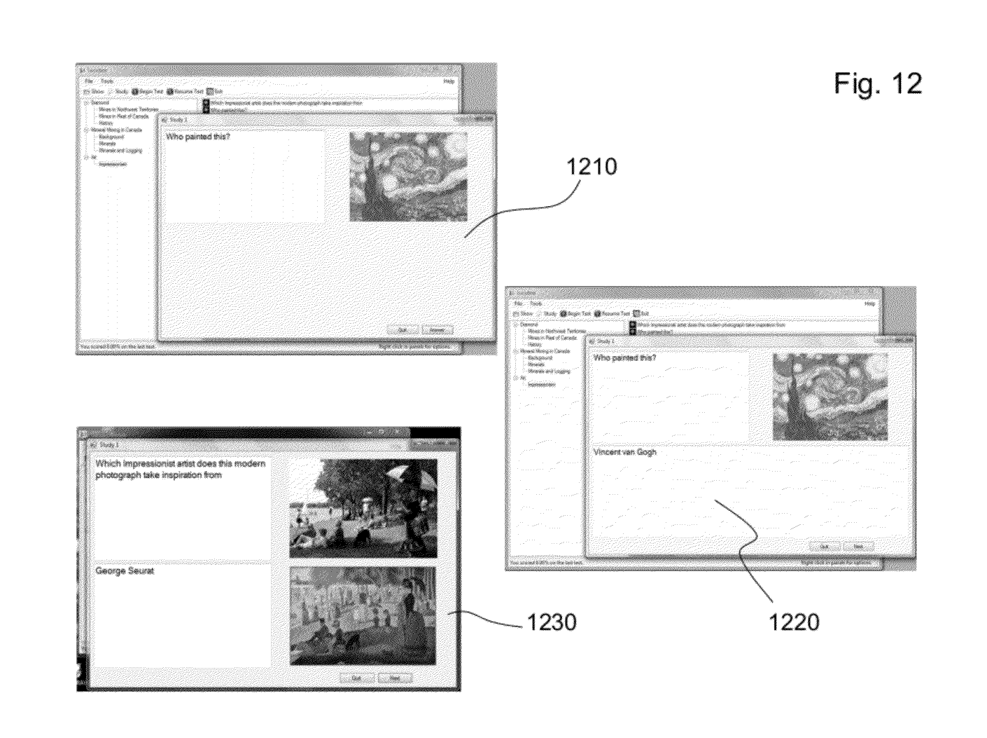

FIG. 12 shows an exemplary sequence of screen capture images 1210 through 1230 for a study session in respect of a question set within the learning tool. In first screen capture image 1210 the user has selected to study the question sub-set “Impressionism” under “Art” presenting them with the first question. Next in second screen capture image 1220 the user has selected the “Answer” button and is presented with both the question and answer allowing them to compare their response with that within the learning tool. Further as shown in third screen capture image 1230 the study session continues through all questions in the sub-set or set if started from the higher level “Art” folder and presents all the information the user has captured in building the question set.

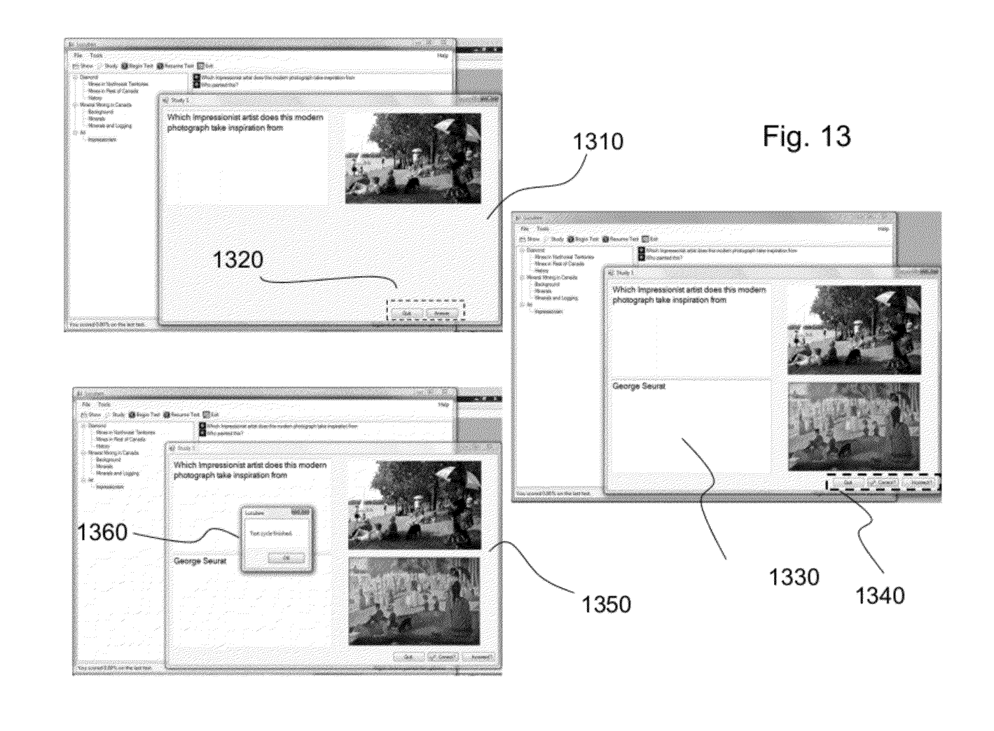

FIG. 13 shows an exemplary sequence of screen capture images 1310 through 1330 for a test in respect of a user for the “Impressionism” sub-set under the “Art” question set using the learning tool. Upon selecting the “Test” option with the “Impressionism” question set highlighted the learning tool randomly selects a question from the set to present to the user in first screen capture image 1310. Having viewed the question and constructed their answer, be it in the users head, on paper etc, they select the “Answer” button as opposed to “Quit” within the options button set 1320. At this point the learning tool presents the user with the answer as shown in second screen capture image 1330. The user then selects a response using the quiz button set 1340 which are “Quit”, “Correct”, and “Incorrect”.

If the user selects “Correct” the learning tool updates counters indicating how many times the user has got the question correct and how many times that question has been asked, whilst in “Incorrect” the learning tool updates only the counter for the number of times the question has been asked. If the number of times the question has been answered correctly exceeds a predetermined count then the learning tool removes the question from the set to be asked to the user. If the user continues with the test and answers all questions correctly the requisite number of times then they will be presented with third screen capture image 1350 which contains a pop-up window 1360 indicating the test has been completed satisfactorily.

It would be apparent to one skilled in the art that the windows discussed in the above figures relating to exemplary embodiments of the present invention are not necessarily of fixed location and size upon the users display but in common with most applications for computers may be sized dynamically and positioned by the user. Additionally other screens such as options including but not limited to text size, sound, and number of times to answer question correctly would be part of the learning tool but have been omitted as their inclusion does not add to the description of the present invention.

The above-described embodiments of the present invention are intended to be examples only. Further it would be evident to those skilled in the art that these embodiments may be combined in different manners to provide variants of the learning tool. Alterations, modifications and variations may be effected to the particular embodiments by those of skill in the art without departing from the scope of the invention, which is defined solely by the claims appended hereto.

Further in many of the exemplary embodiments described supra the process flows include a step of the user entering an answer in response to the question. It would be apparent to one skilled in the art that this answer may be stored temporarily, stored semi-permanently, or deleted. Such entering of the answer may be beneficial in making the user structure an answer. However, such entry may be omitted without deviating from the invention as the user in determining whether the answer is correct or not is determined by the user. Alternatively in other embodiments of the invention the user may be provided with an answer to a question and be required to determine whether the provided answer is correct or not.

What is claimed is:

1. A computer based method of providing a user with a study aid comprising:
a) receiving from the user at least an indication of a subject matter for a plurality of study topics and storing the subject matter within a computer readable database;
b) receiving from the user at least a first item of a plurality of first items, each first item of the plurality of first items representing a predetermined portion of a question;
c) receiving from the user at least a second item of a plurality of second items, each second item of the plurality of second items representing a predetermined portion of an answer to the question; and
d) storing the plurality of first items and the plurality of second items within the computer readable database as a study topic of the plurality of study topics together with at least an association to the at least an indication of the subject matter.

2. A computer based method according to claim 1 further comprising:
e) receiving from the user of a request to at least one of study and perform a test on a predetermined portion of the contents of the computer readable database, the request including an indication of the subject matter to be at least one of studied and the user tested on;
f) retrieving a first study topic of the plurality of study topics, the first study topic being associated with the indicated subject matter and selected in a pseudorandom manner from the plurality of study topics associated with the indicated subject matter;
g) presenting the plurality of first items of the first study topic representing the question to the user;
h) receiving an indication from the user to present the answer to the question to the user; and
i) presenting the plurality of second items of the first study topic representing the answer to the user.

3. A computer based method according to claim 2 further comprising:
j) receiving from the user an indication of the accuracy of a user response to the question, the accuracy determined by the user in dependence upon at least the plurality of second items representing the answer;
k) storing at least one of a first tag indicative of the accuracy of the user response, a second tag indicative of the presentation of the first study topic of the plurality of study topics to the user in the computer readable database, and a third tag indicative of the first tag meeting a first predetermined criterion, the one of the first tag, second tag, and third tag being stored within the computer readable database with an association to the first study topic of the plurality of study topics.

4. A computer based method according to claim 3 wherein;
at least one of the first tag and second tag is determined in dependence upon a counter retrieved from the computer readable database, the counter associated with the first study topic.

5. A computer based method according to claim 1 wherein;
receiving an indication of the subject matter comprises receiving at least one of a user selection from a list of subject matter already within the computer readable database and receiving input from the user relating to a new subject matter.

6. A computer based method according to claim 1 wherein;
receiving at least one of the first item of the plurality of first items and the second item of the plurality of second items comprises at least one of receiving content from the user, selecting content from a computer memory, acquiring content comprising a predetermined portion of a display presenting information to the user, and capturing content from a source provided by the user.

7. A computer based method according to claim 1 wherein;
receiving at least one of the first item of the plurality of first items and the second item of the plurality of second items comprises receiving data representing at least one of text, audio, video, and audio-visual content.

8. A computer based method according to claim 1 wherein;
storing at least one of at least a first item of the plurality of first items and at least a second item of the plurality of second items comprises storing a Universal Resource Locator associated with a source of the least a first item of the plurality of first items and the at least a second item of the plurality of second items.

9. A computer based method according to claim 2 wherein;
retrieving a first study topic of the plurality of study topics comprises retrieving a first study topic of the plurality of study topics with its associated third tag meeting a second predetermined criterion.

10. A computer based method according to any of claim 1 further comprising:
l) receiving from the user a request to export the subject matter;
m) retrieving the plurality of study topics associated with the subject matter;
n) exporting the plurality of study topics associated with the subject matter to a computer readable medium.

11. A computer based method according to claim 1 further comprising:
o) receiving from the user a request to import a plurality of study topics;
p) receiving from the user an indication of a subject matter;
q) importing the plurality of study topics from a computer readable medium with an association to the subject matter.

12. A computer based method according to claim 1 further comprising:
r) receiving from the user a request to import a plurality of study topics relating to a subject matter, the request comprising at least the subject matter;
s) receiving from the user at least one identity of a plurality of identities;
t) identifying occurrences of remote study topics upon computer readable media associated with the one identity of the plurality of identities, the remote study topics determined in dependence upon at least the request;
u) importing the remote study topics with an association to the subject matter.

13. A computer based method according to claim 12 wherein;
receiving the at least one identity of a plurality of identities comprises receiving at least one of an address of a contact within an address book of the user, an address, a name of a social network, and a name of a user group of a social network.

14. A computer based method according to claim 12 wherein;
steps (t) and (u) are repeated for all addresses associated with the at least one identity of the plurality of identities when the at least one identity is at least one of the name of a social network, and the name of a user group of a social network

15. A computer based method according to claim 12 wherein;
the request further comprises at least one keyword of a plurality of keywords.

16. A computer based method according to claim 12 wherein;
each remote study topics is identified in dependence upon the remote study topic fulfilling a predetermined criterion with respect to the plurality of keywords.

17. A computer based method according to claim 3 further comprising:
v) marking the subject matter as completed when at least one of all the third tags associated with the plurality of study topics meet a first predetermined criterion and all the first tags associated with the plurality of study topics meet a second predetermined criterion.

18. A computer based method according to claim 1 further comprising:
w) receiving from the user of a request to at least one of study and perform a test on a predetermined portion of the contents of the computer readable database, the request including an indication of the subject matter to be at least one of studied and the user tested on;
x) retrieving a first study topic of the plurality of study topics, the first study topic being associated with the indicated subject matter and selected in a pseudorandom manner from the plurality of study topics associated with the indicated subject matter;
y) presenting the plurality of first items of the first study topic representing the question to the user;
z) presenting a first answer to the user, the first answer selected in a pseudorandom manner from the plurality of answers associated with the plurality of study topics of the subject matter; and
aa) receiving an indication from the user as to whether the first answer is the correct answer to the first question.

19. A system comprising:
a microprocessor;
a display, the display for presenting audio-visual information to a user of the system;
at least one user input device and a user pointing device, the user input device for receiving information from the user and the user pointing device for controlling an object displayed to the user on the display;
a first computer storage medium, the first computer storage medium having stored thereupon a computer readable database;
a second computer storage medium, the second computer storage medium having stored thereupon a plurality of computer readable commands; wherein in operation the microprocessor retrieves and executes a first predetermined portion of plurality of computer readable commands such that in operation the system performs the following steps:
i) receiving from the user via the user input device at least an indication of a subject matter for a plurality of study topics and storing the subject matter within the computer readable database;
ii) receiving from the user via the user input device at least a first item of a plurality of first items, each first item of the plurality of first items representing a predetermined portion of a question;
iii) receiving from the user via the user input device at least a second item of a plurality of second items, each second item of the plurality of second items representing a predetermined portion of an answer to the question;
iv) storing the plurality of first items and the plurality of second items within the computer readable database as a study topic of the plurality of study topics together with at least an association to the at least an indication of the subject matter;
v) receiving from the user via at least one of the user input device and user pointing device a request to at least one of study and perform a test on a predetermined portion of the contents of the computer readable database, the request including an indication of the subject matter to be at least one of studied and the user tested on;
vi) retrieving from the computer readable database a first study topic of the plurality of study topics, the first study topic being associated with the indicated subject matter and selected in a pseudorandom manner from the plurality of study topics associated with the indicated subject matter;
vii) presenting the plurality of first items of the first study topic representing the question to the user via the display;
viii) receiving an indication via at least one of the user input device and the user pointing device a request from the user to present the answer to the question to the user; and
ix) presenting the plurality of second items of the first study topic representing the answer to the user via the display.

20. A computer based method according to claim 19 further comprising:
retrieving from the second computer storage medium a second predetermined portion of the plurality of computer executable commands and executing the second predetermined portion of the plurality of computer executable commands such that in operation the system performs the following steps:
x) receiving from the user via at least one of the user input device and the user pointing device at least an indication of the accuracy of a user response to the question, the accuracy determined by the user in dependence upon at least the plurality of second items representing the answer;
xi) storing at least one of a first tag indicative of the accuracy of the user response, a second tag indicative of the presentation of the first study topic of the plurality of study topics to the user in the computer readable database, and a third tag indicative of the first tag meeting a first predetermined criterion, the one of the first tag, second tag, and third tag being stored within the computer readable database with an association to the first study topic of the plurality of study topics.

21. A computer based method according to claim 19 further comprising:
retrieving from the second computer storage medium a third predetermined portion of the plurality of computer executable commands and executing the third predetermined portion of the plurality of computer executable commands such that in operation the system performs the following steps:
xii) receiving from the user via at least one of the user input device and the user pointing device a request to export the subject matter;
xiii) retrieving the plurality of study topics associated with the subject matter from the computer readable database;
xiv) exporting the plurality of study topics associated with the subject matter to a third computer readable medium.

22. A computer based method according to claim 19 further comprising:
retrieving from the second computer storage medium a fourth predetermined portion of the plurality of computer executable commands and executing the fourth predetermined portion of the plurality of computer executable commands such that in operation the system performs the following steps:
xv) receiving from the user via at least one of the user input device and the user pointing device a request to import a plurality of study topics;
xvi) receiving from the user via at least one of the user input device and the user pointing device an indication of a subject matter;
xvii) importing the plurality of study topics from a fourth computer readable medium with an association to the subject matter and storing the plurality of study topics within the computer readable database.

23. A computer based method according to claim 19 further comprising:
retrieving from the second computer storage medium a fifth predetermined portion of the plurality of computer executable commands and executing the fifth predetermined portion of the plurality of computer executable commands such that in operation the system performs the following steps:
xviii) receiving from the user via at least one of the user input device and the user pointing device a request to import a plurality of study topics relating to a subject matter, the request comprising at least the subject matter;
xix) receiving from the user via at least one of the user input device and the user pointing device at least one identity of a plurality of identities;
xx) identifying occurrences of remote study topics upon computer readable media associated with the one identity of the plurality of identities, the remote study topics determined in dependence upon at least the request;
xxi) importing the identified remote study topics with an association to the subject matter and storing the identified remote study topics within the computer readable database.
